(19) United States
(12) Patent Application Publication
(10) Pub. No.: US 2026/0162091 A1
(43) Pub. Date: Jun. 11, 2026

(54) SELF-CHECKOUT PRODUCT IMAGE GENERATION SYSTEM

(71) Applicant: TOSHIBA GLOBAL COMMERCE SOLUTIONS, INC., Durham, NC (US)

(72) Inventor: Eric B. VUILLERMET, Chapel Hill, NC (US)

(21) Appl. No.: 18/972,624

(22) Filed: Dec. 6, 2024

(51) Int. Cl. G06Q 20/20; G06Q 30/0601; G06T 11/00

(52) U.S. Cl. CPC G06Q 20/201; G06Q 20/202; G06Q 30/0603; G06T 11/00

(57) ABSTRACT

The following relates to a method and apparatus for updating an item catalog at a point of sale system. Item catalogs include item descriptions and generally, an image corresponding to the item description. However, instances may arise where an image corresponding to the item description has not yet been included in the catalog. In such embodiments, the catalog includes instructions for the point of sale system to generate an image for the first item. In some embodiments, the instructions are a text prompt entered in the catalog before it is sent to a point of sale system. The text prompt includes instructions for an image generating AI system to generate an image corresponding to the text prompt. The point of sale system sends these instructions to the image generating AI system.

### BACKGROUND

The present disclosure relates to artificial intelligence (AI), including image and text prompt generation. AI models can translate text descriptions or other input data into detailed, visually accurate images. Models can be trained on large datasets containing paired images and textual descriptions, enabling them to learn complex patterns, textures and styles. By interpreting input prompts, AI systems can produce artwork, realistic depictions or concept visuals across a wide range of themes and styles.

### BRIEF DESCRIPTION OF THE DRAWINGS

FIG. 1 illustrates a point of sale system, according to some embodiments.

FIG. 2 illustrates a flowchart of a point of sale system updating an item catalog, according to some embodiments.

FIG. 3 illustrates a point of sale system, according to some embodiments.

FIG. 4 a flowchart of a point of sale system updating an item catalog, according to some embodiments.

### DETAILED DESCRIPTION

Embodiments herein relate to updating an item catalog at a point of sale system. Item catalogs include item descriptions and generally, an image corresponding to the item description. However, instances may arise where an image corresponding to the item description has not yet been included in the catalog. In such embodiments, the catalog includes instructions for the point of sale system to generate an image for the first item. In some embodiments, the instructions are a text prompt entered in the catalog before it is sent to a point of sale system. The text prompt includes instructions for an image generating AI system to generate an image corresponding to the text prompt. The point of sale system sends these instructions to the image generating AI system, retrieves the generated image, and then displays the image on the point of sale system to represent the item.

In other embodiments, the point of sale system detects that there is no image corresponding to the image description on the item catalog. In this embodiment, a text prompt is not present in the catalog either. The point of sale system then sends instructions to a prompt generating AI system, which generates a prompt (e.g., a text prompt) instructing the generation of an image corresponding to the item description. The generated prompt is then sent to an image generating AI system which generates the image corresponding to the item description. The item catalog is updated with the image.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

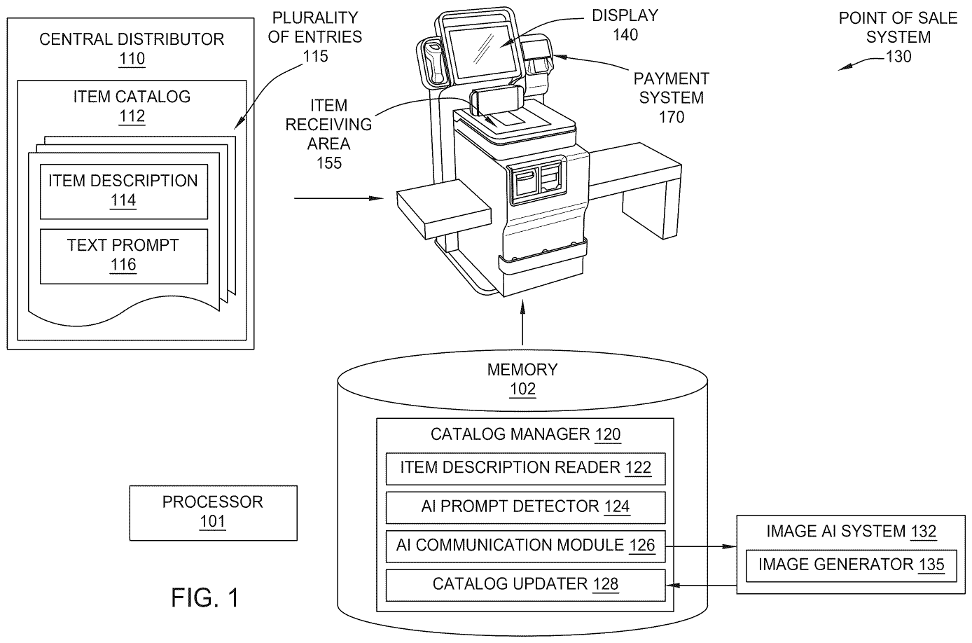

FIG. 1 illustrates a catalog updating system. A central distributor 110 contains an item catalog 112. The central distributor 110 acts as a centralized location where the item catalog is generated. The item catalog 112 contains a plurality of entries 115. Each of the plurality of entries 115 contains an item description 114 and either a matching image corresponding to the item description 114, or a text prompt 116. The central distributor 110 sends the item catalog 112 to each of a plurality of point of sale systems, such as the point of sale system 130.

The point of sale system 130 includes a display 140. The display 140 can display information to the customer such as the identity of the item detected by the point of sale system 130, a list of items already purchased, cost of the items, the AI generated image corresponding to an item description in the catalog, etc. The display 140 could be a touch screen for user interaction, or may not have touch capabilities. If the display 140 is a touch screen, it can serve as an input/output (IO) device for receiving customer input.

Although not shown, the point of sale system 130 can also include one or more cameras disposed to view an item-receiving area 155 on which a shopper places items for purchase. For example, a camera may be disposed in a downward direction. Moreover, to improve the ability to successful identify an item, cameras may also be disposed on the sides of the point of sale system 130.

The item-receiving area 155 defines an area where a customer can place an item for purchase so it can be identified by, for example, scanning a barcode, reading an radio frequency identification (RFID) tag, capturing images of the item and using an the item recognition application, and the like. In one embodiment, the item-receiving area 155 can include a weight sensor (e.g., a scale) or pressure sensors to identify an outline of the item, but this is not a requirement.

The payment system 170 of the point of sale system 130 can include a credit card reader, chip reader, near field communication (NFC) reader, coin/currency machine, and the like.

Within the point of sale system 130 is a catalog manager 120 which can be implemented on a computing system with a processor 101, and a memory 102, within the point of sale system 130. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 102 generally includes program code for performing various functions related to use of the catalog manager 120. The program code is generally described as various functional “applications” or “modules” within the memory 102, although alternate implementations may have different functions and/or combinations of functions. Within the memory 102, the catalog manager 120 updates the item catalog 112, which is discussed in further detail below.

The catalog manager 120 includes an item description reader 122, an AI prompt detector 124, an AI communication module 126 and a catalog updater 128.

In the embodiment illustrated in FIG. 1, the point of sale system 130 receives the item catalog 112 from the central distributor 110. The central distributor 110 acts as a centralized hub for managing and distributing the item catalog 112 to the plurality of point of sale systems. Of the plurality of entries 115 within the item catalog 112, some entries have a complete item description paired with an image of the item described, whereas other entries include an item description 114 paired with a corresponding text prompt 116, and no image corresponding to the item description 114. The text prompt 116 includes an instruction for the point of sale system 130 to generate an image for the first item. An example of a text prompt for generating an image for a d'anjou pear would be:

This is the JSON for Pears:
{
“catalogName”: “CATALOG_0545”,
“groupName”: “D_310”,
“displayName”: {
“default”: “PEARS-DANJOU”
},
“skuId”: “4416”,
“imageGenerator Prompt”: “pear d'anjou on a white background”
}

Items in this context can be an unpackaged item that is sold at the store where the point of sale system 130 is located (e.g., fresh fruit or vegetables).

Once the point of sale system 130 receives the item catalog 112, the item description reader 112 interprets the data contained in the item description 114. The item description reader 122 can process the data contained in the item catalog 112, and extract relevant details from the item description 114 (e.g. the item's name, features, pricing, etc.).

The AI prompt detector 124 of the catalog manager 120 detects the text prompt 116 in lieu of an image corresponding to the item description 114. The AI prompt detector 124 may detect the text prompt 116 using a variety of text recognition techniques such as pattern matching, natural language processing, etc. The AI prompt detector 124 may detect the text prompt 116 within the item catalog 112 entry by scanning the entry for certain keywords, phrases, or identifiers using queries or algorithms. Additionally, the AI prompt detector 124 may use machine learning models to understand context and semantics.

After detecting the text prompt 116, the AI prompt detector 124 communicates with the AI communication module 126. The AI communication module 126 extracts the text prompt 116 detected by the AI prompt detector 124 and distributes it to the image AI system 132.

The image AI system 132 is an AI system specialized for generating images. To achieve this specialization, the image AI system 132 can specialize in interpreting descriptions (such as the descriptions contained in the text prompt 116) and creating visual outputs based on these interpretations. The image AI system 132 can combine natural language processing with generative machine learning models, such as diffusion models or generative adversarial networks. When the image AI system 132 is provided with an instruction prompt, the image generator 135 may analyze the text using natural language processing techniques to understand the content, context and details, breaking the prompt into components like objects, actions, styles, settings, etc. In some embodiments, the text prompt 116 may come in a format that is already parsed.

Each point of sale system of the plurality of point of sale systems can independently communicate with the image AI system 132, so each point of sale system can receive an independently generated image.

The image generator 135 can use textual cues to generate an image that aligns with the text prompt 116. Techniques such as latent diffusion modeling allow the system to produce detailed, high-quality images by iteratively refining the visual output. To ensure alignment with the text prompt 116, the image generator 135 may incorporate feedback mechanisms, refining the image until the image matches the instructions set forth in the text prompt 116.

Once the image is generated, the image generator 135 sends the generated image back to the catalog manager 120. At the catalog manager 120, the catalog updater 128 updates the item catalog 112, replacing the text prompt 116 with the image generated by the image AI system 132.

The catalog updater 128 may integrate image processing or content management software to update the text prompt 116 in the item catalog 112 with the AI generated image. The image received from the image generator 135 can be analyzed by the catalog updater 128 to ensure compatibility with the item catalog's 112 format, resolution, designs, etc. The catalog updater 128 can include a system that replaces the text of the text prompt 116 with the image. The catalog updater 128 can reference a database or template where the text prompt 116 is stored in the item catalog's 112 entry 115, and embed the image in its place. The catalog updater 128 can dynamically resize or reformat the image to fit seamlessly within the item catalog 112 layout while preserving design consistency. The updated item catalog 112 may then be displayed on the display 140.

The catalog updater 128 can receive the AI generated image and dynamically resize, reformat, or convert the image from one format to another, so that it can fit within its designated spot in the item catalog. Upon receiving the image, the catalog updater 128 can analyze the dimensions, resolution, and aspect ratio of the image to ensure the image fits the catalog seamlessly. For example, the AI generated image may not match the color scheme, background, size, resolution, etc. of the other images in the catalog. The catalog updater 128 can harmonize the AI generated image with the other images already in the catalog. This process can include resizing while preserving the image's aspect ratio to avoid distortion, or cropping non-essential areas to mat the dimensions of the target space.

Once adjustments are calculated, the catalog updater 128 can apply the changes using image processing libraries or software. Advanced algorithms can help ensure that resizing operations maintain visual quality, avoiding pixilation or blurring. The resized image can be integrated into the catalog, dynamically placed in its designated spot with proper alignment and spacing. These applied transformations streamline the catalog creation process, ensuring that images are consistently formatted and visually appealing across different entries without manual editing.

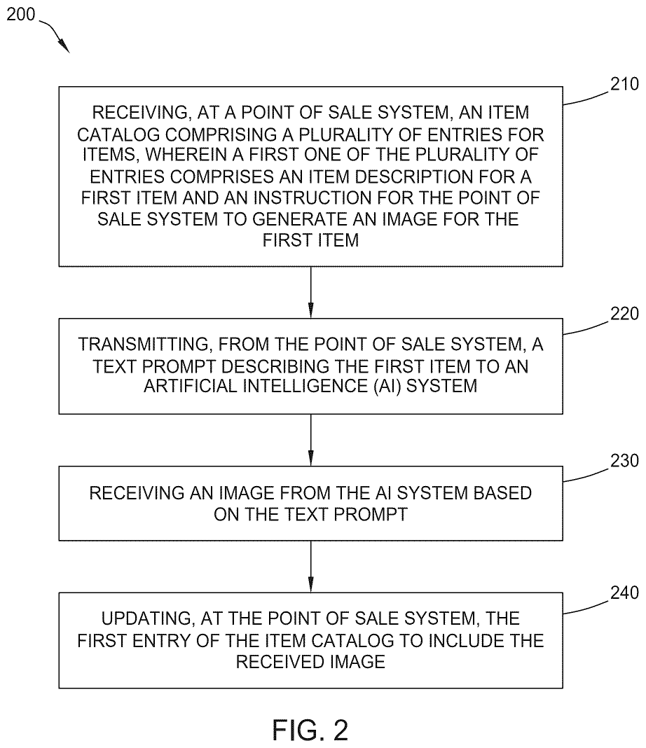

FIG. 2 illustrates a flowchart 200 for updating the catalog with the AI generated image.

At block 210 the point of sale system receives an item catalog from the central distributor.

The item catalog is a digital catalog containing a plurality of entries. The entries can pertain to different items, and in one example the items refer to an unpackaged items sold at the store where the point of sale system is located.

The central distributor can create the catalog with text prompt entries corresponding to images of items in a manual or automated process. Once the catalog is ready to be distributed, the central distributor can send it to a plurality of point of sale systems using distribution mechanisms such as a cloud-based application program interface (API), secure file transfer protocol (FTP), or other network-based methods.

At block 220 the catalog manager of the point of sale system transmits the instruction prompt embedded in the item catalog to an image AI system.

As discussed in FIG. 1, the catalog manager contains components, such as the AI prompt detector 124 and item description reader 122. These components help understand the received entries from the item catalog and help determine whether the entries contain a text prompt. If the AI prompt detector 124 detects a text prompt, the text prompt is sent to the image AI system. Also as discussed in FIG. 1, the image AI system reads the text prompt and generates an image based on the instructions contained in the text prompt. The image AI system can use a plurality of techniques to generate the image, discussed in FIG. 1.

At block 230 the point of sale system receives the image generated by the image AI system based on the text prompt. Also as described in FIG. 1, the AI system sends the generated image back to the catalog manager of the point of sale system. The generated image may undergo various tests conducted by the image generator 135 to ensure it fits within the item catalog entry, and to ensure that the text prompt has been adequately addressed.

At block 240 the catalog updater of the catalog manager updates the item catalog entry to include the AI generated image. In one embodiment, the catalog updater replaces the section of the entry with the written text prompt with the AI generated image. The updated image can be shown on the display 140 in various scenarios, such as when a user scans the physical item for purchase, when a user wishes to look up the item, when the user is browsing the catalog, etc. This process is also described in FIG. 1.

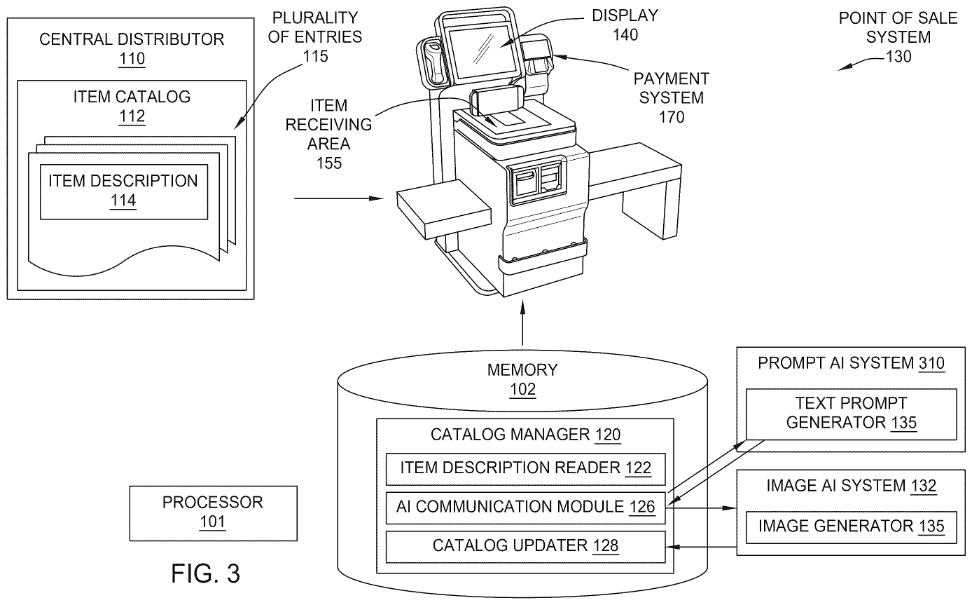

FIG. 3 illustrates another embodiment of the catalog manager 120, where the item catalog does not contain a text prompt. Rather, item catalog 112 contains a plurality of entries 115, some with both an item description and corresponding image, and others with an item description 114 and no corresponding image and no corresponding text prompt. Similar to the embodiment described in FIG. 1, the central distributor 110 sends the item catalog 112 to a plurality of point of sale systems, such as the point of sale system 130.

The point of sale system 130 receives the item catalog 112 at its catalog manager 120. Also similar to the embodiment described in FIG. 1, the catalog manager's 120 item description reader 122 interprets the item description 114 contained in the entries of the item catalog 112.

The item description reader 122 can extract the item description 114 from the item catalog 112 and send the item description 114 to the AI communication module 126. The item description reader 122 can extract the item description 114 from the catalog entry using natural language processing techniques, or data analysis, among other methods. The item description reader 122 can scan the item catalog entry to identify its structure and content, breaking it into sections, paragraphs or labeled data fields that enable the item description reader to identify the item description 114. Once the item description reader 122 locates the item description 114, it passes the item description 114 to the AI communication module 126.

In this embodiment, the AI communication module 126 sends the received item description 114 to a prompt AI system 310. The prompt AI system 310 is an AI system specialized in generating prompts, such as the text prompt 116 in FIG. 1. The prompt AI system 310 receives the item description 114 and uses its text prompt generator 320 to generate a text prompt for the image AI system 132 by leveraging natural language processing and generative algorithms. The text prompt generator 320 interprets the item description 114, identifying key elements such as the object's type, characteristics, and context. For example, if the description is “a red apple” the text prompt generator 320 recognizes attributes such as “red” and “apple.”

The text prompt generator 320 uses these extracted details to construct a detailed and actionable text prompt readable by the image AI system 132. This process can involve applying predefined templates or context aware generative models to ensure the prompt is clear and aligned with the intended task for the image AI system 132.

Once the prompt is generated, it is sent back to the AI communication module 126. The AI communication module 126 then sends the generated text prompt to the Image AI system 132. Similar to the process described in FIG. 1, the image AI system 132 reads the prompt and generates an image corresponding to the image described in the text prompt. The image is sent to catalog manager 120 where the catalog updater 128 updates the catalog with the generated image, also in a process similar to the process described in FIG. 1.

In other embodiments, the prompt AI system sends the generated prompt directly to the image AI system 132.

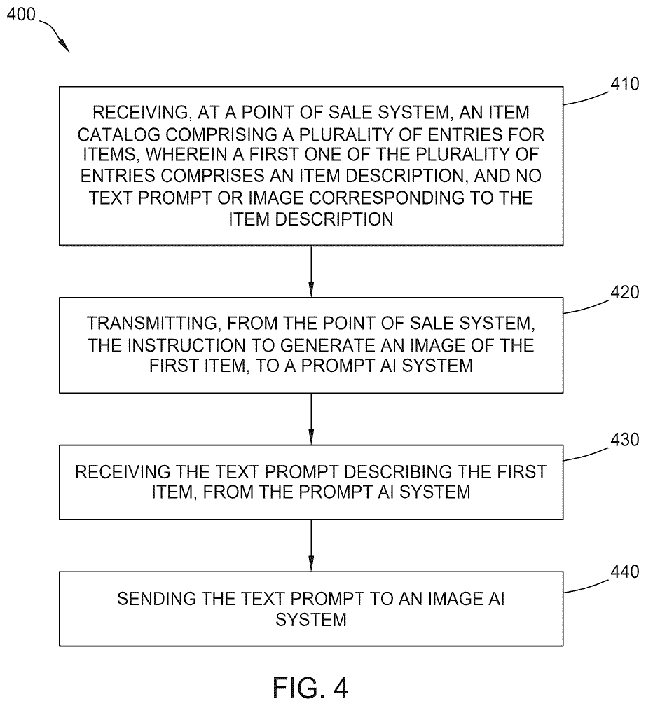

FIG. 4 illustrates a flowchart 400 of an embodiment where the text prompt is not included in the catalog that is sent to the catalog updater.

At block 410 the catalog manager receives a catalog from the central distributor. A similar process is described in FIG. 2, however in this embodiment, some entries of the catalog do not contain a corresponding image to an images description, and the entries with missing images do not contain text prompts for an AI system to generate the corresponding image.

At block 420 the AI communication module of the catalog manager transmits an instruction to generate an image of an item described in the item catalog entry, to a prompt AI system. However, the instruction is not in the form of a text prompt. Rather, in one embodiment, the AI communication module interprets the lack of image as an instruction to communicate with a prompt AI system. This communication involves the AI communication module sending the prompt AI system the description of the image extracted from the received catalog. As described in FIG. 3, the prompt AI system receives the item description found in the catalog. The prompt AI uses the description to generate a text prompt instructing an image AI system to generate an image corresponding to the prompt.

The text prompt can be generated using a variety of methods, as described in FIG. 3.

At block 430 the AI communication module receives, from the prompt AI system, the generated text prompt, and at block 440, the AI communication module sends the text prompt to the image AI system. This process is described in FIG. 3. Quality checks may also be implemented to ensure the text prompt meets the expectations of the image AI system, such that the image AI system can smoothly interpret the text prompt and generate an accurate image corresponding to the item description.

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguideT or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., the catalog manager) or related data available in the cloud. For example, the catalog manager 120 and the image AI system 132 could execute on a computing system in the cloud and update the item catalogs accordingly. In such a case, the catalog manager 120 could update the item catalogs and store the updated item catalogs at a storage location in the cloud. [EXAMPLE: In such a case, the gaming application could monitor ongoing user interactions to identify whether a notable event has occurred during the course of any given gaming session and store an indication of such awards at a storage location in the cloud.] Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A method comprising:
receiving, at a point of sale system, an item catalog comprising a plurality of entries for items, wherein a first one of the plurality of entries comprises an item description for a first item and an instruction for the point of sale system to generate an image for the first item;
transmitting, from the point of sale system, a text prompt describing the first item to an artificial intelligence (AI) system;
receiving an image from the AI system based on the text prompt;
updating, at the point of sale system, the first one of the plurality of entries of the item catalog to include the received image; and
displaying, at the point of sale system, the image, from the updated item catalog.

2. The method of claim 1, further comprising:
transmitting, from the point of sale system, the instruction to generate an image of the first item, to a second AI system; and
receiving the text prompt describing the first item, from the second AI system.

3. The method of claim 2, wherein the second AI system is specialized in generating text prompts to describe the first item.

4. The method of claim 1, wherein the AI system is specialized in generating images based on reading the text prompt.

5. The method of claim 1, wherein the item catalog is received from a centralized location by a plurality of point of sale systems.

6. The method of claim 5, wherein each of the plurality of point of sale systems receives an independently generated image.

7. The method of claim 1, wherein the item is an unpackaged item being sold at a store.

8. The method of claim 1, wherein the item catalog comprises an image corresponding to a second item description.

9. A system comprising:
one or more processors; and
one or more memories configured to store an application, which, when executed by a combination of the one or more processors, causes the combination of the one or more processors to perform an operation, the operation comprising:
receiving, at a point of sale system, an item catalog comprising a plurality of entries for items, wherein a first one of the plurality of entries comprises an item description for a first item and an instruction for the point of sale system to generate an image for the first item;
transmitting, from the point of sale system, a text prompt describing the first item to an artificial intelligence (AI) system;
receiving an image from the AI system based on the text prompt;
updating, at the point of sale system,, the first one of the plurality of entries of the item catalog to include the received image; and
displaying, at the point of sale system, the image, from the updated item catalog.

10. The system of claim 9, further comprising:
transmitting, from the point of sale system, the instruction to generate an image of the first item, to a second AI system; and
receiving the text prompt describing the first item, from the second AI system.

11. The system of claim 10, wherein the second AI system is specialized in generating text prompts to describe the first item.

12. The system of claim 9, wherein the AI system is specialized in generating images based on reading the text prompt.

13. The system of claim 9, wherein the item catalog is received from a centralized location by a plurality of point of sale systems.

14. The system of claim 13, wherein each of the plurality of point of sale systems receives an independently generated image.

15. The system of claim 9, wherein the item is an unpackaged item being sold at a store.

16. The system of claim 9, wherein the item catalog comprises a image corresponding to a second item description.

17. A computer program product for updating an item catalog, the computer program product comprising:
a computer-readable storage medium having computer-readable program code embodied therewith, the computer-readable program code executable by one or more computer processors configured to perform operations comprising:
receiving, at a point of sale system, an item catalog comprising a plurality of entries for items, wherein a first one of the plurality of entries comprises an item description for a first item and an instruction for the point of sale system to generate an image for the first item;
transmitting, from the point of sale system, a text prompt describing the first item to an artificial intelligence (AI) system;
receiving an image from the AI system based on the text prompt;
updating, at the point of sale system, the first one of the plurality of entries of the item catalog to include the received image; and
displaying, at the point of sale system, the image, from the updated item catalog.

18. The computer-readable program code of claim 17, further executable to perform operations further comprising:
transmitting, from the point of sale system, the instruction to generate an image of the first item, to a second AI system; and
receiving the text prompt describing the first item, from the second AI system.

19. The computer-readable program code of claim 17, wherein the item is an unpackaged item being sold at a store.

20. The computer-readable program code of claim 17, wherein the item catalog comprises a second entry of an image corresponding to a second item description.
